(19) United States
(12) Patent Application Publication
(10) Pub. No.: US 2007/0266897 A1
(43) Pub. Date: Nov. 22, 2007

(54) Polyurethane Compositions That Can be Cured at Low Temperatures and Contain Uretdione Groups

(75) Inventor: Emmanouil Spyrou, Schermbeck (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA AG, Dusseldorf (DE)

(21) Appl. No.: 10/591,815

(22) PCT Filed: Jan. 13, 2005
(86) PCT No.: PCT/EP05/50121

§ 371 Date: Jul. 24, 2007

(30) Foreign Application Priority Data
Mar. 6, 2004 (DE) 10 2004 011 005.0

(51) Int. Cl. C09K 17/02; B01J 31/00; C07F 9/02; C08G 18/16

(52) U.S. Cl. 106/287.29; 502/164; 528/49; 528/51; 568/11; 568/9

(57) ABSTRACT

Polyurethane compositions which contain uretdione groups and can be cured at a low temperature.

The invention relates to polyurethane compositions which contain uretdione groups and cure at low baking temperatures, to processes for preparing such compositions, and to their use for producing plastics, especially coatings and adhesives.

Externally or internally blocked polyisocyanates are valuable crosslinkers for thermally crosslinkable polyurethane (PU) coating and adhesive compositions.

For instance, DE-A 27 35 497 describes PU coatings having outstanding weathering stability and thermal stability. The crosslinkers whose preparation is described in DE-A 27 12 931 are composed of ε-caprolactam-blocked isophorone diisocyanate containing isocyanurate groups. Also known are polyisocyanates which contain urethane, biuret or urea groups and whose isocyanate groups are likewise blocked.

The drawback of these externally blocked systems lies in the elimination of the blocking agent during the thermal crosslinking reaction. Since the blocking agent may thus be emitted to the environment it is necessary on ecological and workplace hygiene grounds to take particular measures to clean the outgoing air and/or to recover the blocking agent. The crosslinkers, moreover, are of low reactivity. Curing temperatures above 170° C. are required.

DE-A 30 30 539 and DE-A 30 30 572 describe processes for preparing polyaddition compounds which contain uretdione groups and whose terminal isocyanate groups are irreversibly blocked with monoalcohols or monoamines. Particular drawbacks are the chain-terminating constituents of the crosslinkers, which lead to low network densities in the PU coatings and hence to moderate solvent resistances.

Hydroxyl-terminated polyaddition compounds containing uretdione groups are subject matter of EP 0 669 353. Because of their functionality of two they exhibit improved resistance to solvents. Compositions based on these polyisocyanates containing uretdione groups share the feature that, during the curing reaction, they do not emit any volatile compounds. At not less than 180° C., however, the baking temperatures are at a high level.

The use of amidines as catalysts in PU coating compositions is described in EP 0 803 524. Although these catalysts do lead to a reduction in the curing temperature they exhibit considerable yellowing, which is generally unwanted in the coatings sector. The cause of this yellowing is presumed to be the reactive nitrogen atoms in the amidines. They are able to react with atmospheric oxygen to form N-oxides, which are responsible for the discoloration.

EP 0 803 524 also mentions other catalysts which have been used to date for this purpose, but without indicating any particular effect on the curing temperature. Such catalysts include the organometallic catalysts known from polyurethane chemistry, such as dibutyltin dilaurate (DBTL), or else tertiary amines, such as 1,4-diazabicyclo[2.2.2]octane (DABCO), for example.

It was therefore an object of the present invention to find high-reactivity polyurethane compositions containing uretdione groups, these compositions being curable even at very low temperatures and being particularly suitable for producing plastics and also for producing high-gloss or matt, light-stable and weather-stable, high-reactivity coating and adhesive compositions.

Surprisingly it has been found that certain catalysts so greatly accelerate the unblocking of uretdione groups that when uretdione-containing curing agents are used it is possible to achieve a considerable reduction in the curing temperature of polyurethane compositions.

Conventional uretdione-containing polyurethane compositions can be cured only at 180° C. or above under normal conditions (DBTL catalysis). With the aid of the low-temperature-curing polyurethane compositions of the invention it is possible, with a curing temperature of 100 to 160° C., not only to save on energy and (cure) time but also to coat or bond many temperature-sensitive substrates which at 180° C. would give rise to unwanted yellowing, decomposition and/or embrittlement phenomena. Besides metal, glass, wood, leather, plastics, and MDF board, certain aluminum substrates are suitable as well. In the case of the aluminum substrates, an excessively high temperature load sometimes leads to an unwanted change in the crystal structure.

The present invention provides high-reactivity polyurethane compositions containing uretdione groups and essentially comprising
A) at least one uretdione-containing curing agent which is based on aromatic, aliphatic, (cyclo)aliphatic or cycloaliphatic polyisocyanates and hydroxyl-containing compounds and has a free NCO content of less than 5% by weight and a uretdione content of 1-18% by weight,
B) if desired, a hydroxyl-containing or amino-containing polymer having an OH number of between 20 and 500 mg KOH/gram or a comparable amine content,
C) at least one catalyst of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms,
   such that the fraction of the catalyst under C) is 0.001-5% by weight of the total amount of components A) and B),
   it being possible for the catalysts C) to be surrounded by an inert shell and hence encapsulated, and
D) if desired, at least one compound which is reactive toward acid groups and has a weight fraction, based on the total formulation, of from 0.1 to 10%,
E) if desired, at least one acid in monomeric or polymeric form, in a weight fraction, based on the total formulation, of from 0.1 to 10%,
F) if desired, solvents,
G) if desired, auxiliaries and additives.

The invention also provides a process for preparing the polyurethane compositions.

The invention also provides for the use of the polyurethane compositions of the invention for producing liquid and powder coatings on metal, plastic, glass, wood or leather substrates or other heat-resistant substrates.

The invention also provides for the use of the polyurethane compositions of the invention as adhesive compositions for adhesive bonds on metal, plastic, glass, wood or leather substrates or other heat-resistant substrates.

Likewise provided by the invention are metal-coating compositions, particularly for automobile bodies, motorbikes and cycles, architectural components and household appliances, wood-coating compositions, glass-coating compositions, leather-coating compositions, and plastics-coating compositions.

Polyisocyanates containing uretdione groups are well known and are described in, for example, U.S. Pat. No. 4,476,054, U.S. Pat. No. 4,912,210, U.S. Pat. No. 4,929,724, and EP 0 417 603. A comprehensive overview of industrially relevant processes for dimerizing isocyanates to uretdiones is offered by J. Prakt. Chem. 336 (1994) 185-200. Conversion of isocyanates to uretdiones takes place generally in the presence of soluble dimerization catalysts, such as dialkylaminopyridines, trialkylphosphines, phosphoramides or imidazoles, for example. The reaction, conducted optionally in solvents but preferably in their absence, is terminated by addition of catalyst poisons when a desired conversion has been reached. Excess monomeric isocyanate is separated off afterward by short-path evaporation. If the catalyst is sufficiently volatile, the reaction mixture can be freed from the catalyst at the same time as monomer is separated off. In that case there is no need to add catalyst poisons. A broad range of isocyanates is suitable in principle for the preparation of polyisocyanates containing uretdione groups. Preferred for use in accordance with the invention are isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), toluidine diisocyanate (TDI) and tetramethylxylylene diisocyanate (TMXDI). More particular preference is given to IPDI and HDI.

The conversion of these polyisocyanates bearing uretdione groups to curing agents A) containing uretdione groups involves the reaction of the free NCO groups with hydroxyl-containing monomers or polymers, such as polyesters, polythioethers, polyethers, polycaprolactams, polyepoxides, polyesteramides, polyurethanes or low molecular mass di-, tri- and/or tetraalcohols as chain extenders and, if desired, monoamines and/or monoalcohols as chain terminators, and has already been frequently described (EP 0 669 353, EP 0 669 354, DE 30 30 572, EP 0 639 598 or EP 0 803 524). Preferred curing agents A) containing uretdione groups have a free NCO content of less than 5% by weight and a uretdione group content of from 6 to 18% by weight (calculated as C₂N₂O₂, molecular weight 84). Preference is given to using polyesters having an OH number of from 30 to 150 mg KOH/g and an average molecular weight of from 500 to 6000 g/mol and also to monomeric dialcohols, such as ethylene glycol, propane-1,2-diol and -1,3-diol, 2,2-dimethylpropane-1,3-diol, butane-1,4-diol, hexane-1,6-diol, 2-methylpentane-1,5-diol, 2,2,4-trimethylhexane-1,6-diol, 2,4,4-trimethylhexane-1,6-diol, heptane-1,7-diol, dodecane-1,12-diol, 9-octadecene-1,12-diol, thiodiglycol, octadecane-1,18-diol, 2,4-dimethyl-2-propylheptane-1,3-diol, diethylene glycol, triethylene glycol, tetraethylene glycol, trans- and cis-1,4-cyclohexanedimethanol, for example.

Besides the uretdione groups, the curing agents may also contain isocyanurate, biuret, allophanate, urethane and/or urea structures.

As hydroxyl- or amino-containing polymers B) it is preferred to use polyesters, polyethers, polyacrylates, polyurethanes, polyamidoamines, polyethers and/or polycarbonates having an OH number of 20-500 (in mg KOH/gram) or a comparable amine content. Particular preference is given to polyesters having an OH number of 30-150 and an average molecular weight of 500-6000 g/mol. Such binders have been described in, for example, EP 0 669 354 and EP 0 254 152. It will be appreciated that mixtures of the abovementioned polymers can also be used.

The invention also provides for the use of at least one catalyst of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally, for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms, it being possible for these catalysts to be surrounded by an inert shell and hence encapsulated, in polyurethane compositions and also provides the catalysts themselves.

The catalysts C) essential to the invention satisfy the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally, for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms, it being possible for these catalysts to be surrounded by an inert shell and hence encapsulated.

Examples of such catalysts under C) are tetrabutylphosphonium acetate, tetrabutylphosphonium benzotriazolate, tetrabutylphosphonium hydroxide, ethyltriphenylphosphonium acetate, tetraphenylphosphonium phenoxide, trihexyltetradecylphosphonium decanoate and tetrabutylphosphonium fluoride.

It will be appreciated that mixtures of such catalysts can also be used. Particular preference is given to using tetrabutylphosphonium hydroxide. They are present in an amount of 0.001-5% by weight, preferably 0.01-3% by weight, more preferably from 0.5 to 1.5% by weight, based on components A) and B), in the coating or adhesive composition. The catalysts may include water of crystallization, in which case such water is not taken into account when calculating the amount of catalyst used: that is, the amount of water is removed from the calculation. One version of the invention includes the polymeric attachment of such catalysts C) to the curing agent A) or to the hydroxyl-containing polymers B) as well. For example, free alcohol, thio or amino groups of the phosphonium salts can be reacted with acid, isocyanate or gycidyl groups of the curing agents A) or hydroxyl-containing polymers B) in order to integrate the catalysts C) into the polymeric system.

It should be borne in mind in this context that the activity of these catalysts is significantly decreased in the presence of acids. The conventional reaction partners of the uretdione-containing curing agents include hydroxyl-containing polyesters. Because of the way in which polyesters are prepared, they occasionally still include acid groups to a small extent. In the presence of polyesters which carry such acid groups it is appropriate either to use the catalysts mentioned in excess, relative to the acid groups, or else to add reactive compounds which are capable of scavenging acid groups. Both monofunctional and polyfunctional compounds can be used for this purpose.

Reactive acid-scavenging compounds D) are common knowledge in paint chemistry. For example, epoxy compounds, carbodiimides, hydroxyalkylamides or 2-oxazolines, but also inorganic salts such as hydroxides, hydrogencarbonates or carbonates, react with acid groups at elevated temperatures. Suitable examples include triglycidyl ether isocyanurate (TGIC), EPIKOTE 828 (diglycidyl ether based on bisphenol A, Shell), Versatic acid glycidyl esters, ethylhexyl glycidyl ether, butyl glycidyl ether, POLYPOX R 16 (pentaerythritol tetraglycidyl ether, UPPC AG), and other Polypox grades containing free epoxy groups, VESTAGON EP HA 320, (hydroxyalkylamide, Degussa AG), but also phenylenebisoxazoline, 2-methyl-2-oxazoline, 2-hydroxyethyl-2-oxazoline, 2-hydroxypropyl-2-oxazoline, 5-hydroxypentyl-2-oxazoline, sodium carbonate, and calcium carbonate. It will be appreciated that mixtures of such substances are also suitable. These reactive compounds can be used in weight fractions of from 0.1 to 10%, preferably from 0.5 to 3%, based on the total formulation.

Acids specified under E) are all substances, solid or liquid, organic or inorganic, monomeric or polymeric, which possess the properties of a Brønsted acid or a Lewis acid. Examples that may be mentioned include the following: sulfuric acid, acetic acid, benzoic acid, malonic acid, and terephthalic acid, or else copolyesters or copolyamides having an acid number of at least 20.

Suitable solvents under F) include all liquid substances which do not react with other ingredients, examples being acetone, ethyl acetate, butyl acetate, xylene, Solvesso 100, Solvesso 150, methoxypropyl acetate and Dibasic ester.

For the polyurethane compositions it is possible to add the additives G) customary in coatings or adhesives technology, such as leveling agents, e.g., polysilicones or acrylates, light stabilizers, e.g., sterically hindered amines, or other auxiliaries, as described in EP 0 669 353, for example, in a total amount of from 0.05 to 5% by weight. Fillers and pigments, such as titanium dioxide, for example, can be added in an amount up to 50% by weight of the total composition.

Optionally additional catalysts such as are already known in polyurethane chemistry may be present. These are primarily organometallic catalysts, such as dibutyltin dilaurate, or else tertiary amines, such as 1,4-diazabicyclo[2.2.2]octane, for example, in amounts of 0.001-1% by weight.

All of the constituents for preparing the polyurethane composition of the invention can be homogenized in suitable apparatus, such as heatable stirred tanks, kneading apparatus or else extruders, for example, in which upper temperature limits of 120 to 130° C. ought not to be exceeded. The homogeneous mixture of all the constituents may be either solid or liquid depending on starting substances and/or in accordance with the use of solvents. After it has been thoroughly mixed, the composition is applied to the substrate by appropriate techniques, such as rolling or spraying. In the case of solid formulations, application of ready-to-spray powders to suitable substrates can take place by the known methods, such as by electrostatic powder spraying or by fluid-bed sintering electrostatically or otherwise. Application is followed by heating of the coated workpieces for the purpose of curing for from 4 to 60 minutes at a temperature of from 60 to 220° C., preferably from 6 to 30 minutes at from 80 to 160° C.

The subject matter of the invention is illustrated below with reference to examples.

### EXAMPLES

| Ingredients | Product description, manufacturer |
|---|---|
| VESTAGON | curing agent, Degussa AG, Coatings & Colorants, |
| BF 1540 | uretdione content: 16.8%, m.p.: 99-112° C., T_{g}: 78° C. |
| TPAH | tetrabutylphosphonium hydroxide, Aldrich |

m.p.: melting point; T_{g}: glass transition point

General Preparation of Polyurethane Compositions

The comminuted ingredients—curing agent and catalyst—are intimately mixed in an edge runner mill and then homogenized in an extruder at up to 130° C. maximum. The extrudate is cooled, fractionated and ground to a particle size <100 μm with a pinned-disk mill.

Polyurethane Composition A

95.25 parts of VESTAGON BF 1540 and 4.75 parts of TPAH were homogenized at 120° C. in the extruder, as described, fractionated and ground.

Coating Compositions (amounts in % by weight):

Example 1 is based on polyurethane composition A

| Examples | VESTAGON BF 1540 | Butyl acetate/xylene 1:1 | TPAH |
|---|---|---|---|
| 1 | 38.1 | 60 | 1.9 |
| C1* | 40 | 60 | — |

*noninventive, comparative example

The polyurethane compositions were dissolved in the solvent at room temperature with stirring, then knife-coated onto steel sheet (Bonder 901) using a doctor blade, and after brief flash-off to remove the solvent the coated steel was cured in a forced-air oven at 150° C. for 30 minutes (dry film thickness 25-30 μm).

| Examples | MEK test | Pendulum hardness [s] | Remarks |
|---|---|---|---|
| 1 | >100 | 186 | Cured |
| C1* | 8 | not measurable | not cured |

The MEK test (double rubs) reflects the solvent resistance (methyl ethyl ketone) of the coating, while the pendulum hardness allows conclusions to be drawn concerning the hardness of the coating. Both are dependent on the crosslinking of the coating. As can be seen, in inventive example 1 sufficient crosslinking took place, but not in comparative example 1.

What is claimed is:

1. A high-reactivity polyurethane composition containing uretdione groups and essentially comprising
A) at least one uretdione-containing curing agent which is based on aromatic, aliphatic, (cyclo)aliphatic or cycloaliphatic polyisocyanates and hydroxyl-containing compounds and has a free NCO content of less than 5% by weight and a uretdione content of 1-18% by weight,
B) if desired, a hydroxyl-containing or amino-containing polymer having an OH number of between 20 and 500 mg KOH/gram or a comparable amine content,
C) at least one catalyst of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms,
such that the fraction of the catalyst under C) is 0.001-5% by weight of the total amount of components A) and B).

2. A polyurethane composition as claimed in claim 1, comprising
D) at least one compound which is reactive toward acid groups and has a weight fraction, based on the total formulation, of from 0.1 to 10%, and/or
E) at least one acid in monomeric or polymeric form, in a weight fraction, based on the total formulation, of from 0.1 to 10%.

3. A polyurethane composition as claimed in claim 1 or 2, comprising solvents F) and/or auxiliaries and additives.

4. A polyurethane composition as claimed in at least one of claims 1 to 3, comprising uretdione-containing curing agents A) based on isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), toluidine diisocyanate (TDI) and tetramethylxylylene diisocyanate (TMXDI), alone or in mixtures.

5. A polyurethane composition as claimed in claim 4, comprising uretdione-containing curing agents based on IPDI and/or HDI.

6. A polyurethane composition as claimed in at least one of claims 1 to 5, comprising uretdione-containing curing agents A) based on hydroxyl-containing polyesters, polythioethers, polyethers, polycaprolactams, polyepoxides, polyesteramides, polyurethanes, low molecular mass di-, tri- and/or tetraalcohols, monoamines and/or monoalcohols, alone or in mixtures.

7. A polyurethane composition as claimed in claim 6, comprising polyesters and/or monomeric dialcohols.

8. A polyurethane composition as claimed in at least one of claims 1 to 7, comprising as hydroxyl-containing polymers B) polyesters, polyethers, polyacrylates, polyurethanes and polycarbonates, alone or in mixtures.

9. A polyurethane composition as claimed in claim 8, comprising polyesters having an OH number of from 30 to 150 mg KOH/g and an average molecular weight of from 500 to 6000 g/mol.

10. A polyurethane composition as claimed in at least one of claims 1 to 9, wherein catalysts C) are selected from tetrabutylphosphonium acetate, tetrabutylphosphonium. benzotriazolate, tetrabutylphosphonium hydroxide, ethyltriphenylphosphonium acetate, tetraphenylphosphonium phenoxide, trihexyltetradecylphosphonium decanoate and tetrabutylphosphonium fluoride.

11. A polyurethane composition as claimed in at least one of claims 1 to 10, comprising tributylphosphonium hydroxide as catalyst C).

12. A polyurethane composition as claimed in at least one of claims 1 to 11, comprising as component D) epoxy compounds, carbodiimides, hydroxyalkylamides, basic salts and/or 2-oxazolines.

13. A polyurethane composition as claimed in claim 12, comprising triglycidyl ether isocyanurate, EPIKOTE 828®, Versatic acid glycidyl esters, Vestagon EP HA 320, phenylenebisoxazoline, 2-methyl-2-oxazoline, 2-hydroxyethyl-2-oxazoline, 2-hydroxypropyl-2-oxazoline and/or 5-hydroxypentyl-2-oxazoline, sodium carbonate or calcium carbonate, alone or in mixtures.

14. A polyurethane composition as claimed in at least one of claims 1 to 13, comprising as acid E) sulfuric acid, acetic acid, benzoic acid, malonic acid or terephthalic acid or else copolyesters or copolyamides having an acid number of at least 20.

15. A process for preparing a high-reactivity polyurethane composition containing uretdione groups and essentially comprising
A) at least one uretdione-containing curing agent which is based on aromatic, aliphatic, (cyclo)aliphatic or cycloaliphatic polyisocyanates and hydroxyl-containing compounds and has a free NCO content of less than 5% by weight and a uretdione content of 1-18% by weight,
B) if desired, a hydroxyl-containing and/or amino-containing polymer having an OH number of between 20 and 500 mg KOH/gram or a comparable amine content,
B) at least one catalyst of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms,
such that the fraction of the catalyst under C) is 0.001-5% by weight of the total amount of components A) and B), by homogenization.

16. The use of at least one catalyst of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally, for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms in polyurethane compositions.

17. The use as claimed in claim 16, wherein compounds selected from tetrabutylphosphonium acetate, tetrabutylphosphonium benzotriazolate, tetrabutylphosphonium hydroxide, ethyltriphenylphosphonium acetate, tetraphenylphosphonium phenoxide, trihexyltetradecylphosphonium decanoate and/or tetrabutylphosphonium fluoride are used.

18. A catalyst for accelerating the curing of a polyurethane composition, essentially comprising a uretdione-containing curing agent and a hydroxyl-containing polymer, of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally, for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms.

19. A catalyst as claimed in 18, selected from tetrabutylphosphonium acetate, tetrabutylphosphonium benzotriazolate, tetrabutylphosphonium hydroxide, ethyltriphenylphosphonium acetate, tetraphenylphosphonium phenoxide, trihexyltetradecylphosphonium decanoate and/or tetrabutylphosphonium fluoride.

20. A catalyst as claimed in claim 19, consisting of tetrabutylphosphonium hydroxide.

21. The use of a polyurethane composition essentially comprising
A) at least one uretdione-containing curing agent which is based on aromatic, aliphatic, (cyclo)aliphatic or cycloaliphatic polyisocyanates and hydroxyl-containing compounds and has a free NCO content of less than 5% by weight and a uretdione content of 1-18% by weight,
B) if desired, a hydroxyl-containing and/or amino-containing polymer having an OH number of between 20 and 500 mg KOH/gram or a comparable amine content,
B) at least one catalyst of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms,
such that the fraction of the catalyst under C) is 0.001-5% by weight of the total amount of components A) and B), for preparing liquid and pulverulent coating and adhesive compositions.

22. The use as claimed in claim 21, wherein starting compounds as set forth in at least one of claims 2 to 14 are present.

23. The use as claimed in claim 21 or 22 for preparing liquid and pulverulent coating and adhesive compositions for metal, plastic, wood, glass, leather or other heat-resistant substrates.

24. A metal-coating composition essentially comprising a polyurethane composition comprising
A) at least one uretdione-containing curing agent which is based on aromatic, aliphatic, (cyclo)aliphatic or cycloaliphatic polyisocyanates and hydroxyl-containing compounds and has a free NCO content of less than 5% by weight and a uretdione content of 1-18% by weight,
B) if desired, a hydroxyl-containing or amino-containing polymer having an OH number of between 20 and 500 mg KOH/gram or a comparable amine content,
C) at least one catalyst of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms,
such that the fraction of the catalyst under C) is 0.001-5% by weight of the total amount of components A) and B).

25. A wood-coating composition essentially comprising a polyurethane coating composition comprising
A) at least one uretdione-containing curing agent which is based on aromatic, aliphatic, (cyclo)aliphatic or cycloaliphatic polyisocyanates and hydroxyl-containing compounds and has a free NCO content of less than 5% by weight and a uretdione content of 1-18% by weight,
B) if desired, a hydroxyl-containing or amino-containing polymer having an OH number of between 20 and 500 mg KOH/gram or a comparable amine content,
C) at least one catalyst of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms,
such that the fraction of the catalyst under C) is 0.001-5% by weight of the total amount of components A) and B).

26. A leather-coating composition essentially comprising a polyurethane coating composition comprising
A) at least one uretdione-containing curing agent which is based on aromatic, aliphatic, (cyclo)aliphatic or cycloaliphatic polyisocyanates and hydroxyl-containing compounds and has a free NCO content of less than 5% by weight and a uretdione content of 1-18% by weight,
B) if desired, a hydroxyl-containing or amino-containing polymer having an OH number of between 20 and 500 mg KOH/gram or a comparable amine content,
C) at least one catalyst of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms,
such that the fraction of the catalyst under C) is 0.001-5% by weight of the total amount of components A) and B).

27. A plastics-coating composition essentially comprising a polyurethane composition comprising
A) at least one uretdione-containing curing agent which is based on aromatic, aliphatic, (cyclo)aliphatic or cycloaliphatic polyisocyanates and hydroxyl-containing compounds and has a free NCO content of less than 5% by weight and a uretdione content of 1-18% by weight,
B) if desired, a hydroxyl-containing or amino-containing polymer having an OH number of between 20 and 500 mg KOH/gram or a comparable amine content,
C) at least one catalyst of the formula [PR¹R²R³R⁴]⁺ [R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, it being possible for the bridging atoms to be not only carbon but also heteroatoms and, additionally for each radical R¹-R⁴ to have one or more alcohol, amino, ester, keto, thio, urethane, urea or allophanate groups, double bonds, triple bonds or halogen atoms, and R⁵ is either OH or F or R⁶COO where R⁶ is alkyl, aryl, aralkyl, heteroaryl or alkoxyalkyl radicals having 1-18 carbon atoms and being linear or branched and additionally may have one or more alcohol, amino, ester, keto, thio, acid, urethane, urea or allophanate groups, double bonds, triple bonds or halogen atoms,
such that the fraction of the catalyst under C) is 0.001-5% by weight of the total amount of components A) and B).

28. A metal coating as set forth in claim 24 for automobile bodies, motorbikes and cycles, architectural components and household appliances.

29. A coating composition as claimed in one of claims 24 to 28, comprising at least one of components D) to G).

30. A coating composition as claimed in one of claims 24 to 29, comprising compounds as set forth in at least one of claims 2 to 14.
